(19) United States
(12) Patent Application Publication
(10) Pub. No.: US 2014/0201148 A1
(43) Pub. Date: Jul. 17, 2014

(54) INFORMATION PROCESSING APPARATUS, METHOD AND MEDIUM

(71) Applicant: PFU LIMITED, Kahoku-shi (JP)

(72) Inventors: Hirohisa Doui, Kahoku-Shi (JP); Takehiro Nakamura, Kahoku-Shi (JP); Jun Shida, Kahoku-Shi (JP)

(73) Assignee: PFU LIMITED, Kahoku-shi (JP)

(21) Appl. No.: 14/041,787

(22) Filed: Sep. 30, 2013

(30) Foreign Application Priority Data
Jan. 17, 2013 (JP) 2013-006443

(51) Int. Cl. G06F 17/30

(52) U.S. Cl. CPC G06F 17/30011
USPC 707/638

(57) ABSTRACT

Provided is an information processing apparatus including: a setting unit that sets, for electronic documents, a document ID by which an older version or a newer version can be determined among a plurality of sequential electronic documents; a linking unit that links attachment information to an electronic document; a request accepting unit that accepts a request for an electronic document; an attachment information acquiring unit that, in response to acceptance of the request for the electronic document, acquires the attachment information linked to an electronic document of which version is older than the electronic document related to this request based on the document ID; and a response outputting unit that outputs the electronic document related to the request and the acquired attachment information.

### CROSS-REFERENCE TO RELATED APPLICATION

This application is based upon and claims the benefit of priority of the prior Japanese Patent Application No. JP2013-006443, filed on Jan. 17, 2013, the entire contents of which are incorporated herein by reference.

### FIELD

The present invention relates to a technique to manage electronic documents.

### BACKGROUND

A document management apparatus, in which document information and additional information linked to the document information are held, and when the document information is changed, the additional information linked to the changed document information is changed based on a predetermined rule, has been proposed (see Japanese Patent Application Laid-Open No. 2008-139971).

Further, an annotation information distribution system, where information on an annotation attached to an electronic document is registered in a database in advance, and an annotation of which priority is high is transmitted to each user individually, and the other annotations are edited in batch for each user and transmitted to each user, has been proposed (see Japanese Patent Application Laid-Open No. 2007-334503).

### SUMMARY

An example of an information processing apparatus according to the present disclosure is an information processing apparatus connected to a storage device for storing electronic documents, including: a setting unit that sets, for the electronic documents to be stored in the storage device, electronic document identification information by which an older version or a newer version can be determined among a plurality of sequential electronic documents; a linking unit that links attachment information to an electronic document stored in the storage device; a request accepting unit that accepts a request for an electronic document stored in the storage device; an attachment information acquiring unit that, in response to the request accepting unit accepting a request, acquires the attachment information linked to an electronic document of which version is older than the electronic document related to this request, based on the electronic document identification information; and a response outputting unit that outputs, as a response to the request, the electronic document related to the request and the attachment information acquired by the attachment information acquiring unit.

The present invention can also be comprehended as a method or a program executed by a computer.

The present invention may be applied to a recording medium recording such a program, that can be read by a computer, an apparatus, a machine or the like.

A computer-readable recording medium here refers to a recording medium which stores such information as data and programs electrically, magnetically, optically, mechanically or using chemical action, and which can be read by a computer or the like.

### BRIEF DESCRIPTION OF THE DRAWINGS

FIG. 1 is a diagram depicting a configuration of a system according to an embodiment;

FIG. 2 shows an electronic document display image which is displayed by a client terminal according to the embodiment;

FIG. 3 is a diagram depicting an idea of a functional configuration of an electronic document management server according to the embodiment;

FIG. 4 is a diagram depicting a range of capturing an annotation written on the document using a freehand pen tool according to the embodiment;

FIG. 5 is a table showing data managed by an electronic document database according to the embodiment;

FIG. 6 is a table showing data managed by a comment database according to the embodiment;

FIG. 7 is a table showing data managed by an annotation database according to the embodiment;

FIG. 8 is a table showing data managed by a configuration determination database according to the embodiment;

FIG. 9 is a flow chart depicting a flow of electronic document registering processing according to the embodiment;

FIG. 10 is a flow chart depicting a variation of the flow of the electronic document registering processing according to the embodiment;

FIG. 11 is a flow chart depicting a flow of electronic document transmitting processing according to the embodiment; and

FIG. 12 is a flow chart depicting a flow of message outputting processing according to the embodiment.

### DESCRIPTION OF EMBODIMENTS

Embodiments of an information processing apparatus, an information processing system, and an information processing method and a program according to the present disclosure will now be described with reference to the drawings. The embodiments to be described hereinbelow are merely illustrative, and are not intended to limit the scope of the information processing apparatus, the information processing system, and the information processing method and the program to the concrete configurations in the following description. To carry out the invention, an appropriate configuration may be used according to the embodiment, and various modifications and variations may be made.

An information processing apparatus according to this embodiment is an information processing apparatus connected to a storage device for storing electronic documents, including: a setting unit that sets, for the electronic documents to be stored in the storage device, electronic document identification information by which an older version or a newer version can be determined among a plurality of sequential electronic documents; a linking unit that links attachment information to an electronic document stored in the storage device; a request accepting unit that accepts a request for an electronic document stored in the storage device; an attachment information acquiring unit that, in response to the request accepting unit accepting a request, acquires the attachment information linked to an electronic document of which version is older than the electronic document related to this request, based on the electronic document identification information; and a response outputting unit that outputs, as a response to the request, the electronic document related to the request and the attachment information acquired by the attachment information acquiring unit.

The electronic document here refers to a document that can be processed by a computer, regardless of format and recording method of the document. The electronic document identification information is information by which an older version or a newer version can be determined among a plurality of sequential electronic documents, generated by revision or the like, and is version information, for example. The electronic document identification information however can simply be information by which an older version or a newer version of the electronic documents before and after the revision can be discerned, and is not limited to the general version information. The attachment information is information different from data constituting the body of the electronic document, that is information linked to the electronic document. Examples of the attachment information are a comment attached to an electronic document, an annotation that can be separated from the body of an electronic document, and a snapshot of an electronic document.

According to the information processing apparatus of the present embodiment, an electronic document related to a request and attached information of an electronic document of which version is older than the electronic document related to the request are outputted together, hence inter-user communication, not restricted by information related to a single electronic document, becomes possible, and communication based on electronic documents can be more convenient.

The attachment information acquiring unit may further acquire the attachment information linked to the electronic document related to the request accepted by the request accepting unit, and the response outputting unit may output the electronic document related to the request, the attachment information that is linked to the electronic document related to the request and is acquired by the attachment information acquiring unit, and the attachment information linked to the electronic document of which version is older than the electronic document related to the request.

Thereby the electronic document related to the request, the attachment information of the electronic document related to the request, and the attachment information of the electronic document of which version is older than the electronic document related to the request are outputted together.

The information processing apparatus according to this embodiment may further include an attachment information accepting unit that accepts the attachment information uploaded by a user using a client terminal 9, wherein the linking unit links the attachment information, of which upload is accepted by the attachment information accepting unit, to an electronic document stored in the storage device.

By this configuration, attachment information, such as a comment uploaded by the user, can be linked to the electronic document, and new and old comment information can be outputted with the electronic document.

The linking unit may further link the attachment information, of which upload is accepted by the attachment information accepting unit, to one of portions in the electronic document that have been written by the user.

By this configuration, attachment information, such as a comment uploaded by the user, can be linked to other attachment information, such as write information by the user.

The information processing apparatus according to this embodiment may further include an image generating unit that generates a captured image that includes a portion written by the user from the electronic document. And the information processing apparatus according to this embodiment may further include an uploading unit that uploads attachment information including the captured image.

By this configuration, when the user writes information, the writing of the user and the content of the written information can be notified to other users.

The information processing apparatus according to this embodiment may further include: a detecting unit that detects a correction request comment related to a request to correct the electronic document, out of the attachment information linked to the electronic document; and a message outputting unit that, when the correction request comment is detected, outputs a confirmation message to prompt the user to confirm the detected correction request comment.

By this configuration, when a correction request comment is uploaded, for example, this upload can be notified to other users. The message outputting unit may output a confirmation message that includes the number of correction request comments detected by the detecting unit.

The information processing apparatus according to this embodiment may further include a confirmation state managing unit that manages a state of a confirmation, by a predetermined user, of the correction request comment detected by the detecting unit, wherein the message outputting unit outputs a confirmation message that includes the number of correction request comments which are detected by the detecting unit and of which confirmation state is “unconfirmed”.

By limiting the number of correction request comments to be included in the confirmation message only to unconfirmed correction request comments, other users can accurately know the number of comments which must be confirmed.

The information processing apparatus according to this embodiment may further include: a determining unit that determines, when a new version of an electronic document is accepted, whether a correction request comment, of which confirmation state is “unconfirmed”, exists in attachment information linked to an old version of the electronic document; and a warning outputting unit that outputs a warning when the determining unit determines that an unconfirmed correction request comment exists.

The response outputting unit may output the electronic document related to the request, the attachment information, and an upload content in the case where the electronic document of which version is older than the electronic document related to the request is accepted.

The present disclosure can also be comprehended as a method executed by a computer or a program executed by a computer. The present disclosure can also be comprehended as a recording medium recording such a program, that can be read by a computer, an apparatus, a machine or the like. Here, the recording medium that can be read by a computer or the like refers to a recording medium which stores such information as data and programs electrically, magnetically, optically, mechanically or using chemical action, and which can be read by a computer or the like.

In this embodiment, a case of carrying out the information processing apparatus, the information processing method and the program as an electronic document management server 1 and a method and a program thereof, which are used with a social networking service (SNS) will be described. The information processing apparatus, the information processing method and the program according to the present disclosure can be widely used for a purpose of managing electronic documents, and the application targets of the present disclosure are not limited to the examples shown in this embodiment.

<System Configuration>

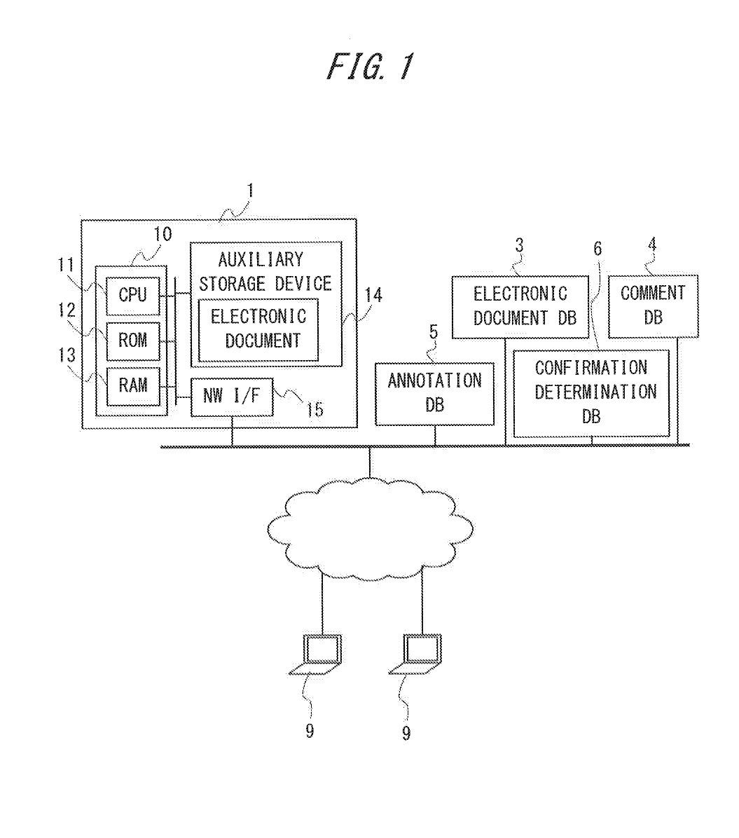

FIG. 1 is a diagram depicting a configuration of a system according to this embodiment. The system according to this embodiment has an electronic document management server 1, and a plurality of client terminals 9 which are communicably connected with the electronic document management server 1 via a network, such as a local area network (LAN) or the Internet.

The electronic document management server 1 is an information processing apparatus that has: a control unit 10 including a central processing unit (CPU) 11, a random access memory (RAM) 12 and a read only memory (ROM) 13; an auxiliary storage device 14; and a network interface 15. For the actual hardware configuration of the information processing apparatus, composing elements may be omitted, replaced or added appropriately according to the embodiment.

The client terminal 9 is an information processing apparatus where a CPU, a RAM, a ROM, a display, an input device such as a mouse and a keyboard, and a network interface for communicating with the electronic document management server 1 are electrically connected (not illustrated). For an actual hardward configuration of the client terminal 9, composing elements may be omitted, replaced or added appropriately according to the embodiment. For example, the client terminal 9 may include, as an input device, an input device other than a mouse and a keyboard (e.g. touch panel installed on a display).

The system according to this embodiment also has various databases which are connected so as to be communicable with the electronic document management server 1. In concrete terms, an electronic document database 3 where the electronic document managing information is stored, a comment database 4 where a comment on an electronic document is stored, an annotation database 5 where write information (annotation) attached to an electronic document is stored, and a confirmation determination database 6 for managing the confirmation state of comments are connected so as to be communicable with the electronic document management server 1. In this embodiment, the electronic document management server 1 and each database may be configured as separate apparatuses, or may be configured as a single apparatus.

In this embodiment, “annotation” refers to information that can be displayed on an electronic document by being attached to the electronic document but does not constitute the electronic document body, and that can be separated from the electronic document. Annotations include, for example, a comment, a remark and a note, lines such as an encircling line or a strike through, and images such as a fill pattern.

Each database is a computer system which has a configuration of a general purpose computer, including a CPU, a RAM, a ROM, an auxiliary storage device, and a network interface or the like, just like the electronic document management server 1 (illustration is omitted).

In this embodiment, an electronic document file (hereafter also called “electronic document”), which is a body of an electronic document, is stored in the auxiliary storage device 14 of the electronic document management server 1. A unique uniform resource locator (URL) for a client terminal 9 to access is attached to an electronic document stored in the auxiliary storage device 14, and this URL is managed by the electronic document database 3. The electronic document may be stored in the electronic document database 3 and managed there.

In this embodiment, the electronic document management server 1 has a function to provide the SNS, which accepts a comment uploaded by the user and links the comment to an electronic document, so as to support communication on the electronic document via a comment. The comment database 4 is a database for managing such a comment according to this embodiment.

In the description on the system according to this embodiment, the function of the information processing apparatus according to the present disclosure is installed in the electronic document management server 1, but the electronic document management server 1 and various databases may be installed on a client terminal 9, or may be installed on the network as a cloud service. If installed as a cloud service, the processing is performed mainly by a plurality of machines distributed on the network, but the plurality of machines distributed on the network can be regarded as a single apparatus that plays a function as a server or a database.

Now an outline of an electronic document display image 90, which is transmitted from the electronic document management server 1 and displayed on the client terminal 9 according to this embodiment will be described. The client terminal 9 is connected to the electronic document management server 1 based on the operation by the user, and requests the electronic document management server 1 to read the electronic document specified by the user. The electronic document management server 1 acquires, from the database, the specified electronic document and the attachment information (comment, annotation and captured image of annotation in the case of this embodiment) attached to the electronic document, generates information for display, and transmits the information to the client terminal 9. The client terminal 9 displays the information received from the electronic document management server 1 using a Web browser application. The displayed electronic document can be checked out or edited via the Web browser application, and a comment, annotation, or the like can be attached to the displayed electronic document via the Web browser application. The application used for display need not be a Web browser application. For example, a dedicated application for reading and editing an electronic document and attachment information thereof may be used.

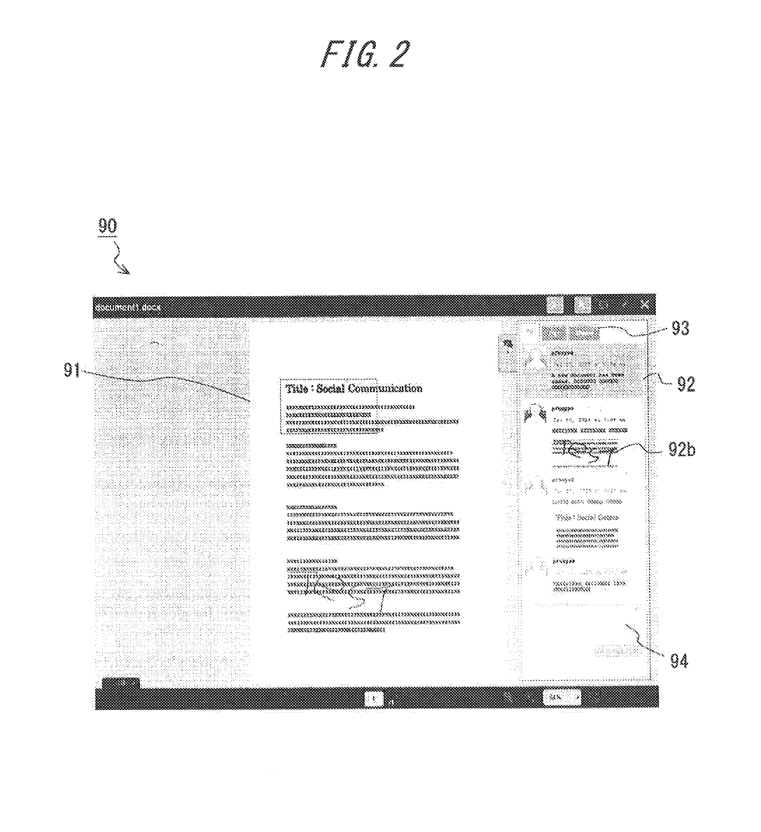

FIG. 2 shows an electronic document display image 90 which is displayed by the client terminal 9 according to this embodiment. The left side of the electronic document display image 90 is an electronic document display section 91, where the electronic document is displayed with annotation (e.g. “test” written by freehand in FIG. 2).

The right side of the electronic document display image 90 is a timeline display section 92 where an uploaded comment on the electronic document is displayed. The comment includes not only text but also a captured image 92b generated by extracting the anotation portion from the electronic document. A switch button or tab 93 to switch the timeline display is displayed above the timeline display section 92. By operating this button or tab 93, the user can switch the timeline to be displayed. The timelines that can be displayed by switching include a timeline of a comment linked to the electronic document displayed in the electronic document display section 91, and a timeline of a comment linked to the electronic document of which version is a previous one of the currently displayed electronic document. The timeline also includes, as a master post, a comment the user uploaded when the electronic document was uploaded or updated.

A comment upload field 94 is displayed below the timeline display section 92. The user can upload a comment by inputting text or the like in the comment upload field 94 and transmitting it. The comment uploaded via this comment upload field 94 is linked to the electronic document displayed in the electronic document display section 91 as attachment information, and is displayed in the timeline display section 92.

As mentioned above, the system according to this embodiment is a system where users can perform communication for electronic document editing with each other using an SNS, and the electronic document and timelines are displayed in parallel. “Timeline” here refers to a list of comments related to the electronic document, and in the timeline display section 92 which is displayed with the electronic document in parallel, a comment on this electronic document (or an electronic document of which version is older than this electronic document) is displayed.

In the SNS according to this embodiment, an electronic document can also be uploaded. The uploaded electronic document is stored in the electronic document management server 1 and is registered in the electronic document database 3, and attachment information can be linked to this electronic document. In this case, a post related to the upload of this electronic document is displayed in the timeline display section 92 as a master post of the comment for this electronic document.

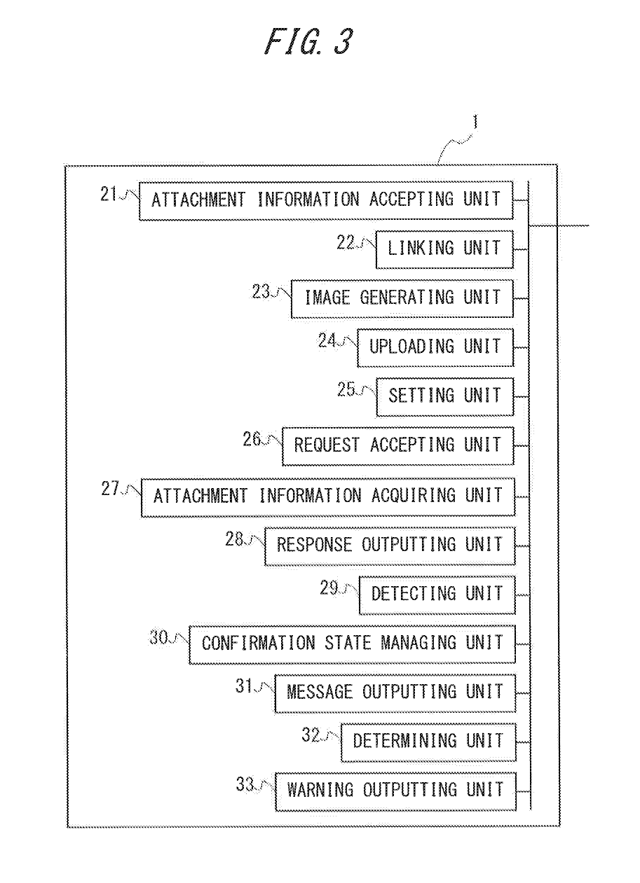

FIG. 3 is a diagram depicting an idea of a functional configuration of the electronic document management server 1 according to this embodiment. In the electronic document management server 1 according to this embodiment, a CPU 11 interprets and executes various programs developed in RAM 12, and controls the various hardware equipped in the electronic document management server 1, whereby the electronic document management server 1 functions as an information processing apparatus including an attachment information accepting unit 21, a linking unit 22, an image generating unit 23, an uploading unit 24, a setting unit 25, a request accepting unit 26, an attachment information acquiring unit 27, a response outputting unit 28, a detecting unit 29, a confirmation state managing unit 30, a message outputting unit 31, a determining unit 32, and a warning outputting unit 33. In the description of this embodiment, these functions are all executed by a general purpose CPU, but a part or all of these functions may be implemented by one or a plurality of dedicated processors.

The attachment information accepting unit 21 accepts the attachment information uploaded by the user using the client terminal 9. According to the system of this embodiment, the user can read an electronic document and attachment information thereof (e.g. comment, annotation, captured image) by displaying the electronic document display image 90 shown in FIG. 2 using the client terminal 9, and the user himself/herself can also upload a comment or assign an annotation to an electronic document using the client terminal 9. The client terminal 9 uploads the attachment information by the user by transmitting information to the electronic document management server 1 according to the comment uploading operation and annotation operation by the user.

The linking unit 22 links attachment information to an electronic document stored in the storage device. By the linking unit 22 linking the attachment information to a target electronic document, it becomes possible to display attachment information in the electronic document display image 90, along with the electronic document, or to screen the attachment information in the later mentioned outputting processing. The attachment information that is linked here includes attachment information of which upload is accepted by the attachment information accepting unit 21, but the attachment information is not limited to the information uploaded by the user. The linking unit 22 may further link the attachment information, of which upload is accepted by the attachment information accepting unit 21, to a specific page of the electronic document, or a specific annotation portion (a portion written by the user). For example, if the user uploads a correction request comment with specifying a specific annotation, this correction request comment is linked not only to the target electronic document, but also to the specified annotation.

The image generating unit 23 generates a captured image, including a portion written by the user (annotation portion), from an electronic document. In the system according to this embodiment, the user can write an annotation of lines and graphics on an electronic document displayed on a Web browser application using a freehand pen tool, a graphic tool or the like. By this annotation, the user can draw a line in a predetermined section of the electronic document, or enclose a predetermined section by a circle or a rectangle. The image generating unit 23 generates a captured image by capturing the annotation added to the electronic document like this as an image, along with the portion of the electronic document where the annotation is added. In this embodiment, the generated captured image is linked to an annotation ID of the annotation that was captured and stored in the annotation database 5.

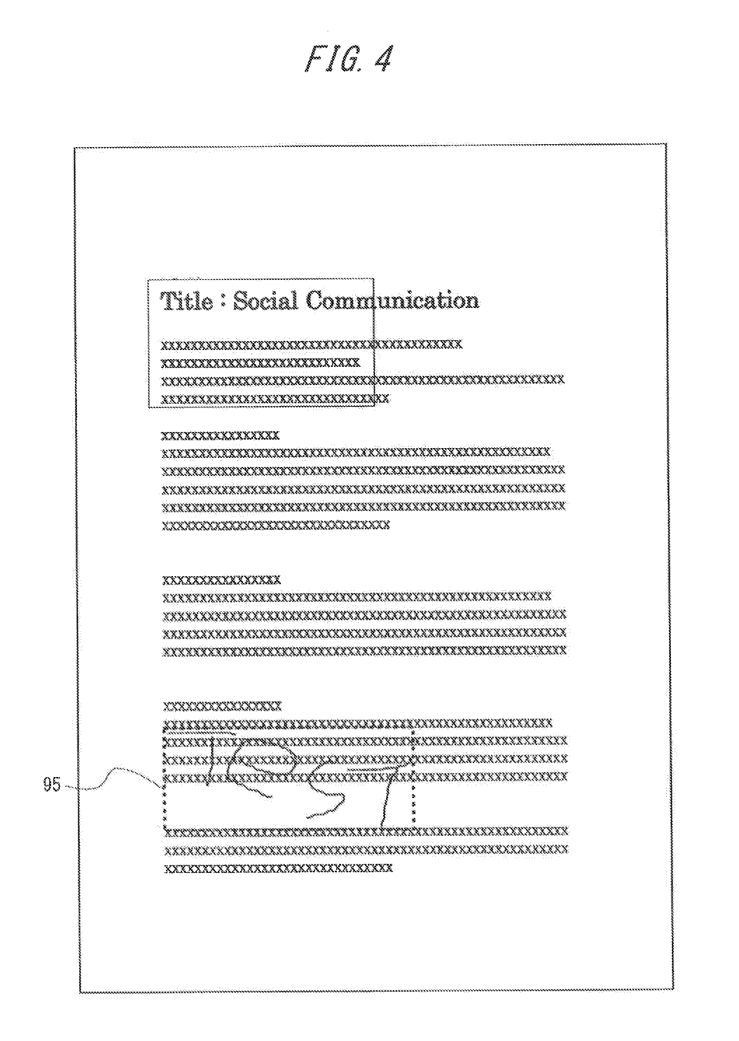

FIG. 4 shows a range 95 where an annotation written in the document by a freehand pen tool is captured according to this embodiment. Then image generating unit 23 acquires a maximum value and a minimum value of the X coordinate and the Y coordinate of the annotation in the document respectively, and generates a captured image by capturing a rectangular range 95 of which vertexes are the acquired four points as an image. The image generating unit 23 may capture a rectangular range of which vertexes are four points that are outside the acquired four points by a predetermined value, so that information around the annotation is included in the captured image.

The uploading unit 24 uploads attachment information including a captured image. According to this embodiment, the uploading unit 24 uploads the captured image captured by the image generating unit 23 to the timeline as a comment linked to the electronic document that was captured. If any user adds an annotation, the captured image is uploaded to the timeline, so the other users can simultaneously recognize the addition of the annotation and the content of the annotation.

The setting unit 25 sets, for the electronic documents to be stored in the storage device, a document ID by which an older version or a newer version can be determined among a plurality of sequential electronic documents. The document ID is information which allows determining an older version or a newer version among a plurality of electronic documents which are sequential due to revision or the like, and in this embodiment, an older version or a newer version among a plurality of electronic documents can be determined by assigning a document ID having a greater value indicating that the electronic document is newer. Whether a plurality of electronic documents are sequential or not can be determined by file names and storage location URLs of the electronic documents. The document ID may include a portion by which whether the electronic document is sequential or not can be determined, and a portion by which newness of an electronic document can be determined (version information).

The request accepting unit 26 accepts a request for an electronic document which is transmitted from a client terminal 9 according to an operation by the user and is stored in the storage device.

The attachment information acquiring unit 27 acquires, in response to the request accepting unit 26 accepting a request, the attachment information linked to an electronic document related to the request accepted by the request accepting unit 26, and the attachment information linked to an electronic document of which version is older than the electronic document related to the request.

The response outputting unit 28 outputs an electronic document related to the request and the attachment information acquired by the attachment information acquiring unit 27 as a response to the request. The attachment information to be outputted here includes attachment information linked to the electronic document related to the request, and attachment information linked to an electronic document of which version is older than the electronic document related to the request. In this embodiment, the attachment information includes not only a comment, annotation and captured image, but also the content of the upload in the case where the electronic document related to the request or the electronic document of which version is older is accepted by the electronic document management server 1 (that is, the content of the master post).

The detecting unit 29 detects attachment information that satisfies a predetermined condition, out of the attachment information linked to an electronic document. According to this embodiment, a correction request comment and a favorable comment are detected as attachment information that satisfies a predetermined condition. The detecting unit 29 searches the contents of the comments using predefined words to indicate requesting a correction or predetermined words to indicate a favorable comment, and if the words to indicate requesting a correction are searched in a comment, the comment is detected as a correction request comment, and if the words to indicate a favorable comment are detected are searched in a comment, this comment is detected as a favorable comment.

The confirmation state managing unit 30 manages a state of confirmation by a predetermined user (the user who uploaded the electronic document in the case of this embodiment) of the attachment information detected by the detecting unit 29. In this embodiment, “unconfirmed” is set if only the correction request comment is detected, and this state is changed to “confirmed” when the user who uploaded the electronic document confirms the correction request comment.

The message outputting unit 31 outputs a confirmation message to prompt the user to confirm the detected attachment information when attachment information that satisfies a predetermined condition is detected. In this embodiment, when a correction request comment or a favorable comment is detected, the message outputting unit 31 outputs a confirmation message to prompt the user to confirm the detected correction request comment or the favorable comment. The confirmation message of the correction request comment includes the number of correction request comments which are detected by the detecting unit 29 and of which confirmation state is “unconfirmed”.

The determining unit 32 determines, when a new version of an electronic document is accepted, whether attachment information linked to an old version of the electronic document includes attachment information (correction request comment in the case of this embodiment) of which confirmation state is “unconfirmed”.

The warning outputting unit 33 outputs a warning when the determining unit 32 determines that unconfirmed attachment information (a correction request comment in the case of this embodiment) exists.

<Data Configuration>

Now data managed by each database used in this embodiment will be described.

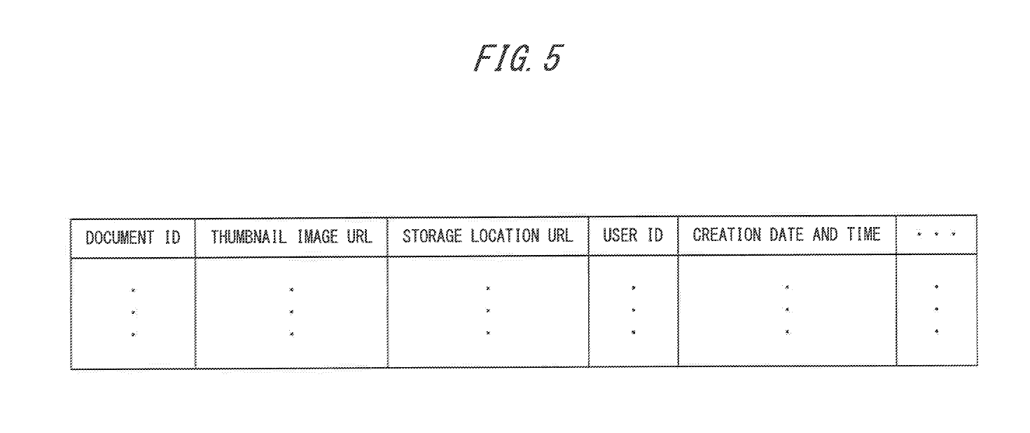

FIG. 5 is a table showing data managed by the electronic document database 3 according to this embodiment. In the electronic document database 3, a document ID, a URL of a thumbnail image of the electronic document, a URL to indicate the storage location of the electronic document, a user ID of a creator of the electronic document (actually a user who uploaded the electronic document), and a creation date and time of the electronic document are stored for each electronic document (electronic document file) to be stored in the electronic document management server 1.

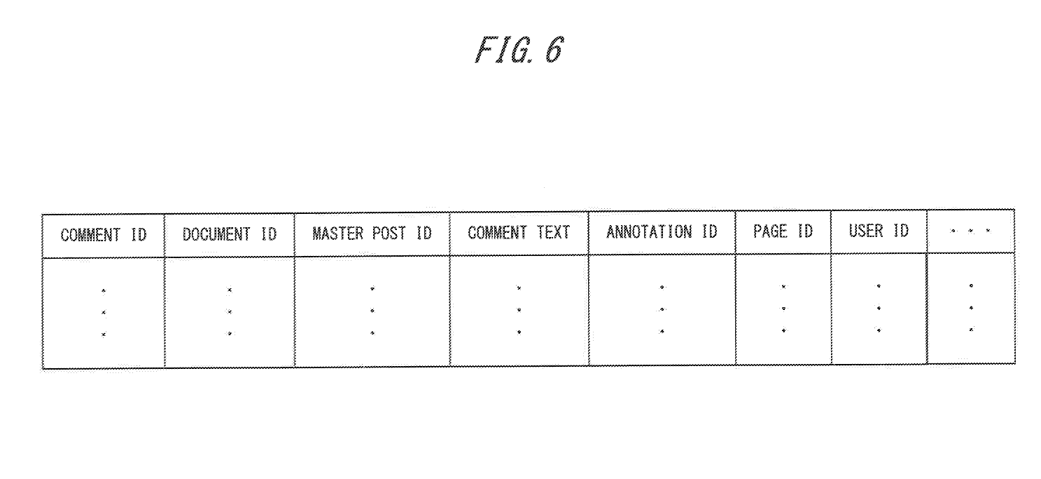

FIG. 6 is a table showing data managed by the comment database 4 according to this embodiment. In the comment database 4, a comment ID, a document ID of an electronic document to which the comment is linked, a comment ID of a master post of the comment (only if the comment is a slave post), a comment text (content), an annotation ID of an annotation to which the comment is linked, a page ID of a page in the electronic document to which the comment is linked, and a user ID of a user who uploaded the comment, are stored for each comment.

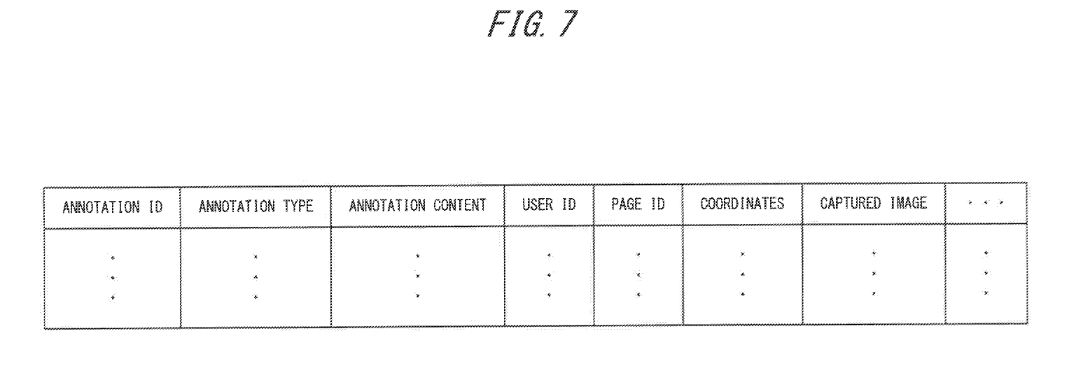

FIG. 7 is a table showing data managed by the annotation database 5 according to this embodiment. In the annotation database 5, an annotation ID, a type of the annotation (e.g. type of graphic, such as a line, a circle, a rectangle, an arrow drawn by freehand, text), a content of the annotation, a user ID of a user who performed annotation, a page ID of a page of an electronic document to which the annotation is linked, coordinates of the annotation, and a captured image of the annotation are stored for each annotation. The content of the annotation can be recorded as information using coordinates in the electronic document or the like. For example, if the annotation is constituted by a line drawn by freehand, the content of the annotation can be represented by coordinates where this line passes through.

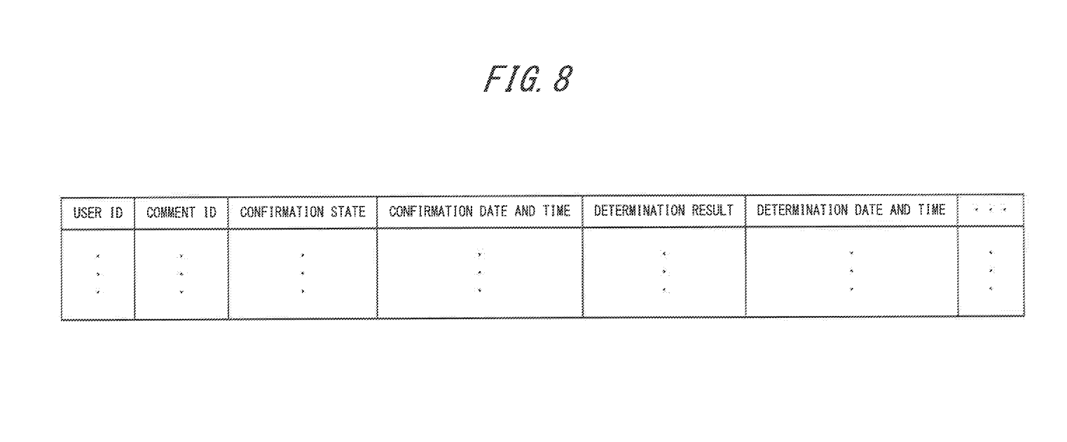

FIG. 8 is a table showing data managed by the confirmation determination database 6 according to this embodiment. In the confirmation determination database 6, a user ID of a user who is supposed to confirm a confirmation target comment (normally a user who uploaded the target electronic document), a comment ID of the confirmation target comment, a confirmation state of the confirmation target comment, a date and time when the confirmation was performed, a determination result, and a date and time when the determination was performed, are stored for each comment examined by the later mentioned screening processing. Here the determination result is information that indicates the result of the screening. According to this embodiment, a value that indicates a type of comment (favorable comment, correction request comment, other comments) is set for the determination result.

<Processing Flow>

Details of the processing according to this embodiment will now be described. Concrete content, sequence or the like of the processing to be described in this embodiment are an example of carrying out the invention. The concrete content, sequence or the like of the processing may be appropriately selected according to an embodiment.

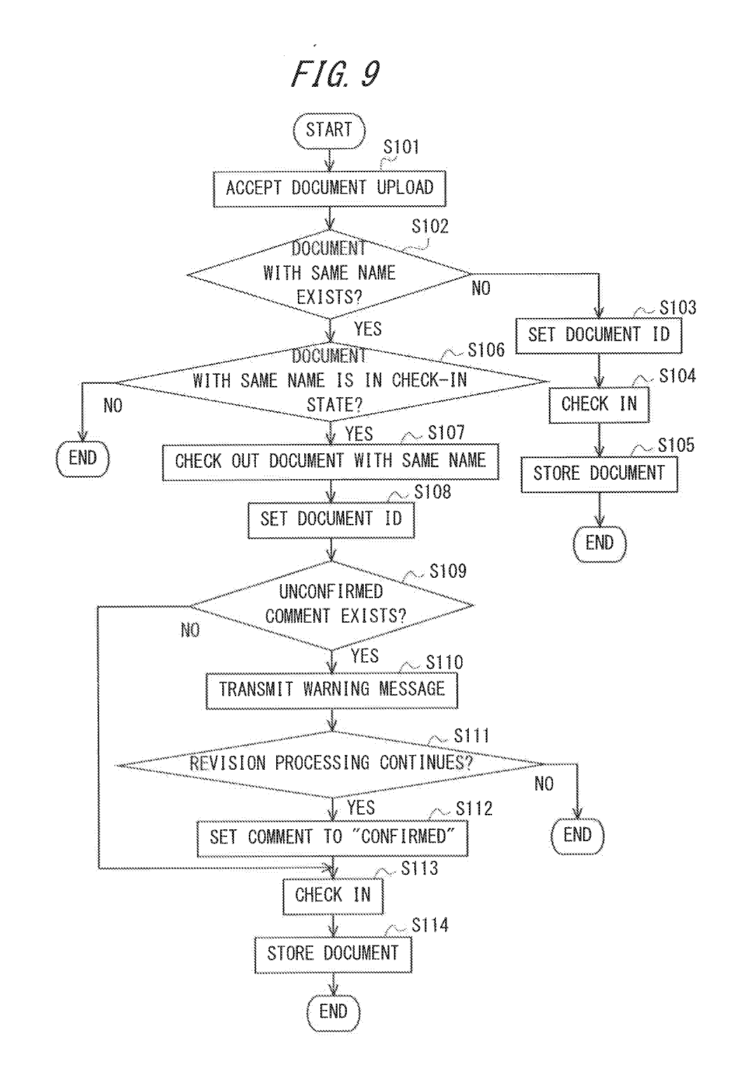

FIG. 9 is a flow chart depicting a flow of electronic document registration processing according to this embodiment. The start of the processing shown in this flow chart is triggered by uploading an electronic document from the client terminal 9 to the electronic document management server 1.

In step S101 and step S102, an upload of an electronic document is accepted and it is determined whether an electronic document with a same name exists or not. The control unit 10 of the electronic document management server 1 receives the electronic document transmitted from the client terminal 9 via a network (step S101). The control unit 10 acquires a file name of the electronic document as a name of the received electronic document, and determines whether an electronic document with a same name as the received electronic document has already been stored (registered) by searching the electronic documents (or the electronic document database 3) stored in the auxiliary storage device 14 (step S102). If it is determined that an electronic document with the same name has been stored in the electronic document database 3, processing advances to step S106. If it is determined that an electronic document with the same name is not stored in the electronic document database 3, then processing advances to step S103.

In this embodiment, the file name of the electronic document is used as the name of the electronic document, but a name other than the file name may be used for the name of the electronic document. For example, a title of the electronic document that is set in metadata or the like within the electronic document may be used as the name of the electronic document.

In step S103 to step S105, new registration processing of an electronic document in the electronic document database 3 is performed. The setting unit 25 sets a new document ID, which does not overlap with an ID of another already registered electronic document, for the electronic document received in step S101, and creates a record for managing this electronic document in the electronic document database 3, so as to register the electronic document in the database (step S103). The document ID which is set here is information by which an older version or a newer version can be determined among a plurality of sequential electronic documents. For example, an older version or a newer version can be differentiated among a plurality of electronic documents by assigning a greater value of a document ID to an electronic document indicating that the electronic document is newer.

Then the control unit 10 sets the status of the electronic document received in step S101 on the electronic document management server 1 to the check-in state (step S104), and the auxiliary storage device 14 of the electronic document management server 1 stores this electronic document (step S105). Then the processing shown in this flow chart ends. In other words, by executing the processing shown in step S103 to step S105, the new document ID is set to the new electronic document, and thereafter the version management by the electronic document management server 1 is enabled.

Here “check-in state” refers to a state where the target electronic amount is not being edited by any user, and “check-out state” refers to a state where the target electronic document is currently being edited by a user, and exclusive control is being performed for editing by other users. The electronic document management server according to this embodiment manages electronic documents by using the check-in state and the check-out state, so that different users performing different editing on a same electronic document is prevented. Check-out processing is unnecessary to add a comment or an annotation, since both are attachment information that can be separated from the electronic document, and the electronic document itself is not revised.

If it is determined in step S102 that an electronic document with a same name is already stored in the electronic document database 3, processing advances to step S106.

In step S106 and step S107, check-out processing is performed if check-out is possible for the electronic document with a same name. The electronic document management server 1 determines whether the newest of the electronic documents with the same name detected in step S102 is in the check-in state (step S106). If the state of the newest electronic document with the same name is not in the check-in state (in other words, in the check-out state where another user is editing), the processing shown in this flow chart ends. If the state of the newest electronic document with the same name is in the check-in state, then this electronic document is set to the check-out state by the user related to the check-out request, and revision (version upgrade) by the electronic document uploaded in step S101 is enabled (step S107). Then processing advances to step S108.

In step S108, a document ID is set for the electronic document. The setting unit 25 assigns a new document ID, which does not overlap with the IDs assigned to other registered electronic documents (by which an older version or a newer version can be determined, among a plurality of sequential electronic documents) to the electronic document received in step S101, and a record for managing this electronic document is created in the electronic document database 3, so as to register this electronic document in the database (step S108). Here a value the same as the document ID assigned to the electronic document before revision is set to a portion of the document ID common to the electronic documents before and after revision, and a value that is different from the electronic document before revision and is greater than the value which is set in the electronic document before revision is set for a version portion of the document ID (portion which is different between the electronic documents before and after revision). Then processing advances to step S109.

In step S109, it is determined whether an unconfirmed comment exists. The determining unit 32 inquires the confirmation determination database 6 so as to determine whether an unconfirmed comment remains in the attachment information linked to the electronic document before the revision. In concrete terms, from the comment database 4, the determining unit 32 extracts a comment ID of the comment linked to the electronic document before the revision by extracting a comment in which the document ID of the electronic document before the revision is set, and determines whether an unconfirmed comment remains by inquiring about the confirmation state of extracted comment IDs to the confirmation determination database 6. Here a comment where a value that indicates “unconfirmed” is set in the confirmation state is determined as an unconfirmed comment. If it is determined that an unconfirmed comment remains for the electronic document before the revision, the processing advances to step S110. If it is determined that no unconfirmed comment remains for the electronic document before the revision, on the other hand, processing from step S110 to step S112 is skipped, and processing advances to step S113.

In step S110 to step S112, processing on an unconfirmed comment is performed. The warning outputting unit 33 generates a warning message to notify a user that an unconfirmed comment remains in the electronic document before the revision, and transmits the warning message to the client terminal 9 (step S110). The client terminal 9 displays the received warning message, and accepts operation by the user to instruct whether the revision processing of the electronic document is continued or not. When the operation by the user is accepted, the client terminal 9 transmits the instruction according to the operation by the user to the electronic document management server 1. The control unit 10 of the electronic document management server 1 determines whether the revision processing of the electronic document is continued or not, according to the instruction received from the client terminal 9 (step S111). If the revision processing of the electronic document is not continued, the revision processing of the electronic document is canceled, and the processing shown in this flow chart ends. If the revision processing of the electronic document is continued, the confirmation state managing unit 30 forcibly sets the unconfirmed comment to “confirmed” (step S112). In concrete terms, the confirmation state managing unit 30 sets the confirmation state of a comment linked to the electronic document before the revision (comment of which confirmation state is set to a value indicating “unconfirmed” according to the determination in step S109) is set to a value indicating “confirmed”. Then processing advances to step S113.

In step S113 and step S114, revision registration processing to the electronic document database 3 is performed for the electronic document. The control unit 10 sets a status of the electronic document on the electronic document management server 1, received in step S101, to “check-in” state (step S113), and the auxiliary storage device 14 of the electronic document management server 1 stores the electronic document (step S114). Then the processing shown in this flow chart ends.

Here the electronic document before the revision is not overwritten by the electronic document after revision, but a different URL is assigned to the electronic document after the revision. The electronic document after the revision registered in this step is managed by the document ID which is different from the document ID of the electronic document before the revision, which is set in step S108.

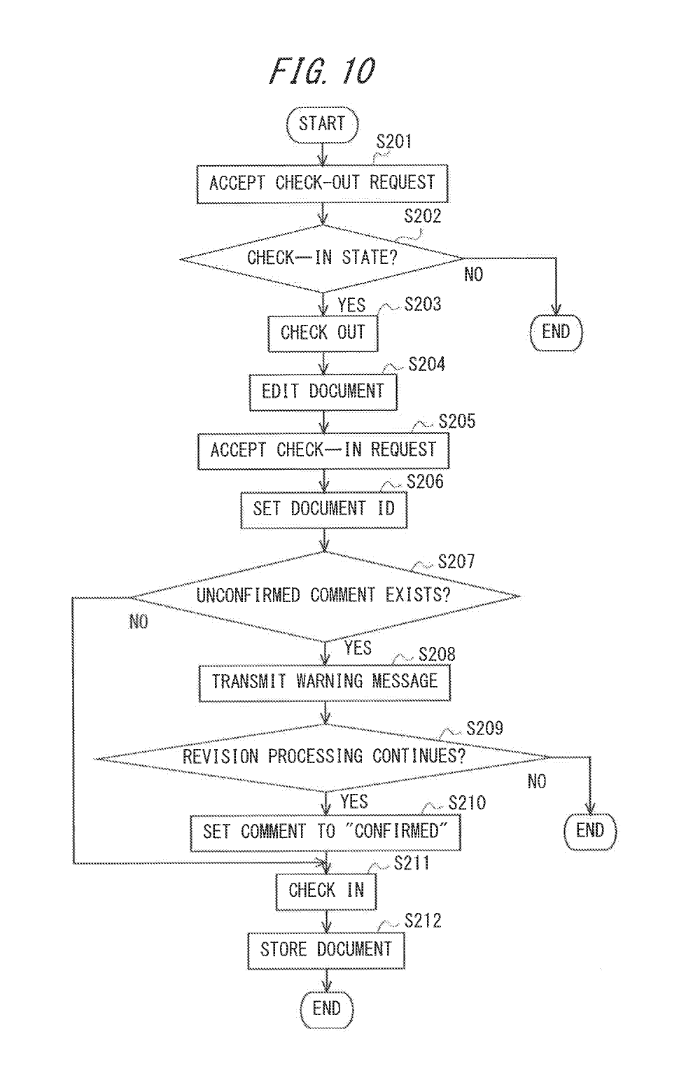

FIG. 10 is a flow chart depicting a variation of the flow of the electronic document registering processing according to this embodiment. The start of the processing shown in this flow chart is triggered by the client terminal 9 transmitting a check-out request with specifying an electronic document of which editing is desired.

In step S201 to step S203, a check-out request for the electronic document is accepted, and the check-out processing is performed if check-out is possible. When a check-out request with specifying an electronic document of which editing is desired is accepted from a client terminal 9 (step S201), the electronic document management server 1 determines whether the current state of the electronic document related to the request is in the check-in state or not (step S202). If the state of the electronic document related to the request is not in the check-in state (that is, this electronic document does not exist, or is in the check-out state where another user is editing this document), the processing shown in this flow chart ends. If the state of the electronic document related to the request is in the check-in state, this electronic document is set to the check-out state for the user related to this check-out request, so that editing from the client terminal 9 is enabled (step S203). Then processing advances to step S204.

In step S204 and step S205, the electronic document is edited and the check-in request is accepted. The user can edit the electronic document via the Web browser application of the client terminal 9 where the check-out operation was performed. The electronic document management server 1 accepts an editing instruction which is transmitted from the client terminal 9 according to the operation of the user, and edits the electronic document (step S204). When the desired editing operation is ended, the user performs the save operation (check-in operation) at the client terminal 9. The electronic document management server 1 accepts the check-in request transmitted from the client terminal 9 according to the operation by the user (step S205). Then processing advances to step S206.

The processing content of step S206 to step S212 is omitted, since this is approximately the same as the processing content of step S108 to step S114 described with reference to FIG. 9. According to the system of this embodiment, not only can an electronic document edited at the client terminal 9 be uploaded, but also an electronic document can be revised by editing the electronic document using the Web browser application.

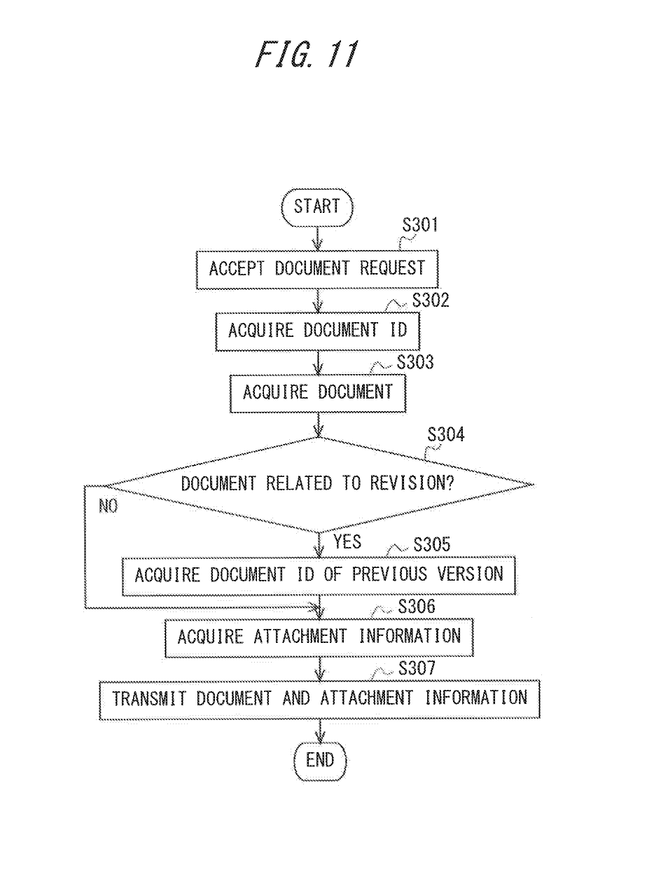

FIG. 11 is a flow chart depicting a flow of the electronic document transmission processing according to this embodiment. The client terminal 9 receives a URL of a thumbnail image stored in the electronic document database 3 from the electronic document management server 1, and displays the thumbnail image of the electronic document on a page of a group managed by an SNS (not illustrated), so that the user selects a desired electronic document based on this thumbnail image. The thumbnail image may be displayed as a content of a post related to this group. If one of the thumbnail images is selected by the user, the client terminal 9 transmits the request for an electronic document corresponding to the thumbnail image to the electronic document management server 1. Then the start of the processing shown in this flow chart is triggered by the reception of the request for any of the electronic documents managed by the electronic document management server 1, transmitted from the client terminal 9.

In step S301 to step S303, the request for the electronic document is received and the document ID of the electronic document related to the request and the file of the electronic document is acquired. The request accepting unit 26 receives the request for any of the electronic documents managed by the electronic document management server 1, transmitted from the client terminal 9 (step S301). When the request is received, the control unit 10 searches the electronic document database 3 with the URL of the electronic document specified in the request received from the client terminal 9, and acquires a document ID of data related to this URL (step S302). Further, the control unit 10 receives the electronic document corresponding to the acquired document ID from the storage location of the electronic document (specified by the URL in this embodiment) (step S303). Then processing advances to step S304.

In step S304 and step S305, if the electronic document to be displayed is a revised electronic document, the document ID before the revision (previous version in the case of this embodiment) is acquired. The control unit 10 searches the electronic document database 3 with the file name of the electronic document specified in the request received from the client terminal 9, and determines whether the electronic document related to the request is an electronic document in connection with the revision, based on whether the document ID related to this file name exists in plurality (step S304). The determination method is not limited to the example described above. For example, a latest document ID related to the specified electronic document is acquired, and whether the document related to the request is an electronic document in connection with revision or not is determined based on the content of the document ID (e.g. referring to the portion corresponding to the version number). If it is determined that the electronic document to be displayed is not an electronic document in connection with the revision, the processing in step S305 is skipped, and processing advances to step S306. If it is determined that the electronic document to be displayed is an electronic document in connection with the revision, on the other hand, the control unit 10 searches the document ID of the electronic document of the previous version having the same file name as the electronic document specified in the request (that is, document before revision), out of the electronic document database 3, and acquires this document ID (step S305). In concrete terms, the control unit 10 searches the document ID of the electronic document of the previous version by extracting a record of which document ID is newest (number is the highest), out of the records which are stored in the electronic document database 3, and of which file names stored in the storage location URL are the same as the electronic document to be displayed, and of which document IDs are older (the number of lower in the case of this embodiment) than the document ID of the electronic document to be displayed. However the method of acquiring the document ID of the previous version differs depending on the format of the document ID, hence an appropriate method can be used according to the embodiment. Then processing advances to step S306.

In step S306, the attachment information linked to the acquired document ID is acquired. In this step, not only the attachment information linked to the document ID of the electronic document related to the request from the client terminal 9 acquired in step S303, but also the attachment information linked to the document ID of the electronic document of the previous version is acquired if the document ID of the previous version is acquired in step S305. By searching the comment database 4 based on the acquired document ID, the attachment information acquiring unit 27 acquires a comment linked to the electronic document related to the request and a comment linked to the electronic document of the previous version. Further, the attachment information acquiring unit 27 searches the annotation database 5 based on the annotation ID which is set in the acquired comment, so as to acquire an annotation and a captured image linked to the electronic document related to the request, and also acquires an annotation and a captured image linked to the electronic document of the previous version. Then processing advances to step S307.

In step S307, the acquired electronic document, comments, annotations and captured images are transmitted to the client terminal 9. The response outputting unit 28 transmits, to the client terminal 9, the electronic document related to the request acquired in step S303, the comments, annotations and captured images that are linked to the electronic document related to the request and are acquired in step S306, and the comments, annotations and captured images linked to the electronic document of the previous version. The response outputting unit 28 then allows the Web browser application of the client terminal 9 to display the data. Then the processing shown in this flow chart ends.

The electronic document display image 90, which the client terminal 9 displays based on the information transmitted as a result of the electronic document transmission processing is as described with reference to FIG. 2. According to the processing in the flow chart described above, not only the electronic document requested by the client terminal 9, but also the attachment information linked to the electronic document of which version is older than this electronic document is outputted, hence inter-user communication, that is not limited to the information linked to a single electronic document, can be implemented.

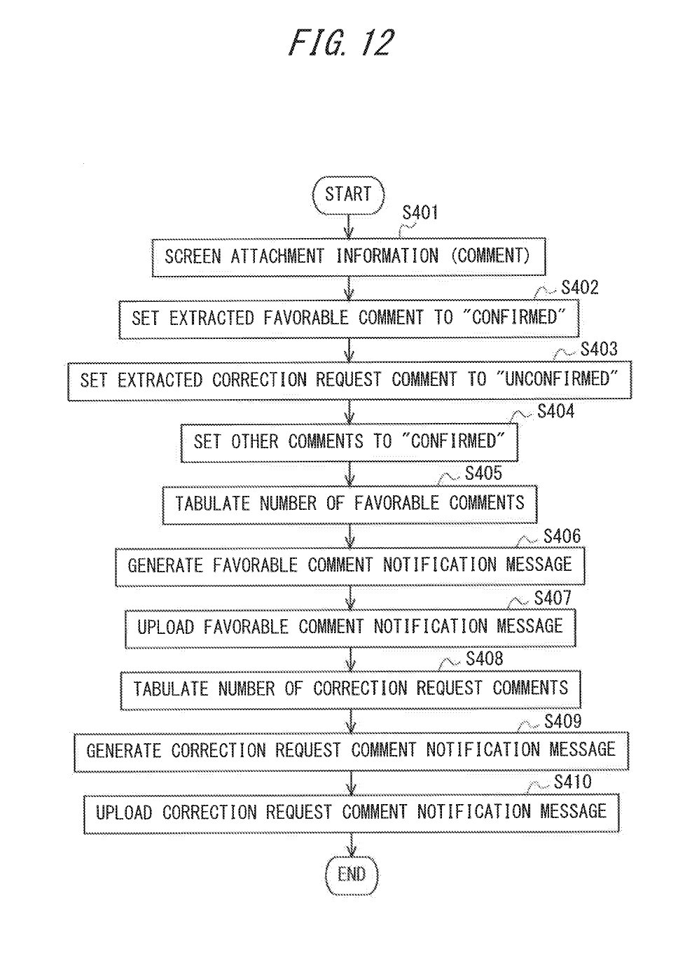

FIG. 12 is a flow chart depicting a flow of message outputting processing according to this embodiment. The processing shown in this flow chart is periodically executed for each electronic document identified by the document ID.

In step S401, the comments stored in the comment database 4 is screened. “Screened” here refers to carefully examining the information stored in a database, in order to extract a comment that satisfies a predetermined condition, out of the comments linked to the target electronic document stored in the comment database 4. The detecting unit 29 detects attachment information that satisfies a predetermined condition (a correction request comment and a favorable comment in the case of this embodiment) out of the attachment information linked to the electronic document. In this embodiment, a correction request comment on the target electronic document is extracted when a predetermined condition being set is that the document ID of the target electronic document is set in the comment, and that words to request correction are included in the comment. In this embodiment, a favorable comment on the target electronic document is extracted when a predetermined condition being set is that the document ID of the target electronic document is set in the comment, and that words to be favorable to the target electronic document are included (step S401). Here the screening is executed until unscreened documents no longer exist. Then processing advances to step S402.

In this embodiment, the targets of screening are only comments, but other attachment information, such as annotations and captured images, may be screened.

In step S402 to step S404, a status of a comment is set. The confirmation state managing unit 30 records a comment ID of an extracted comment in the confirmation determination database 6, for a favorable comment newly extracted by the screening in step S401, and sets the confirmation state corresponding to the comment ID to a value indicating “confirmed” (step S402). The confirmation state managing unit 30 also records a comment ID of the extracted comment in the confirmation determination database 6, for a correction request comment newly extracted by the screening in step S401, and sets the confirmation state corresponding to this comment ID to a value indicating “unconfirmed” (step S403). Further, the confirmation state managing unit 30 records a comment ID in the confirmation determination database 6, for a comment that is screened by the screening in step S401, and is neither a favorable comment nor a correction request comment, and sets the confirmation state corresponding to the comment ID to a value indicating “confirmed” (step S404). Then processing advances to step S405.

In step S405 to step S407, the number of favorable comments is tabulated, and a message to notify the uploader of the electronic document that a favorable comment is received is automatically uploaded. The control unit 10 tabulates the number of favorable comments extracted by the screening in step S401 (step S405). The favorable comments to be tabulated here are favorable comments newly extracted by the screening this time, and favorable comments which were extracted in the previous screening and are in the “screened” state are not tabulated. When the number of favorable comments is tabulated, the message outputting unit 31 generates a message to notify the uploader of the electronic document that favorable comments are received (step S406), and uploads the generated message as a new comment linked to the target electronic document (step S407). The content of the message can be, for example, “Mr./Ms. (user ID), x number of favorable comments newly uploaded for this electronic document”. Here the user ID of the uploader of the electronic document enters the (user ID). Processing then advances to step S408.

In step S408 to step S410, the number of unconfirmed correction request comments is tabulated, and a message to notify the uploader of the electronic document that an unconfirmed correction request comment exists is automatically uploaded. The control unit 10 tabulates the number of comments where a document ID of the target electronic document is set and a value indicating “unconfirmed” is set for the confirmation state in the confirmation determination database 6 (step S408). The correction request comments to be tabulated here are not limited to the correction request comments newly extracted in the screen in step S401. Therefore the correction request comments of which confirmation state remains “unconfirmed”, because the uploader of the electronic document did not perform confirmation operation, become the target of tabulation until the confirmation state becomes “confirmed”. When the number of unconfirmed correction request comments is tabulated, the message outputting unit 31 generates a message to notify the uploader of the electronic document that unconfirmed correction request comments exist (step S409), and uploads the generated message as a new comment linked to the target electronic document (step S410). The content of the message can be, for example, “Mr./Ms. (user ID), x number of unconfirmed correction request comments are uploaded for this electronic document.” Here the user ID of the uploader of the electronic document enters the (user ID). Then the processing shown in this flow chart ends.

In the system according to this embodiment, the automatic upload described above is performed, whereby a message is displayed on the timeline, and confirmation of a predetermined message can be prompted to the uploader of the electronic document.

What is claimed is:

1. An information processing apparatus connected to a storage device for storing electronic documents, comprising:
a setting unit that sets, for the electronic documents to be stored in the storage device, electronic document identification information by which an older version or a newer version can be determined among a plurality of sequential electronic documents;
a linking unit that links attachment information to an electronic document stored in the storage device;
a request accepting unit that accepts a request for an electronic document stored in the storage device;
an attachment information acquiring unit that, in response to the request accepting unit accepting a request, acquires the attachment information linked to an electronic document of which version is older than the electronic document related to the request, based on the electronic document identification information; and
a response outputting unit that outputs, as a response to the request, the electronic document related to the request and the attachment information acquired by the attachment information acquiring unit.

2. The information processing apparatus according to claim 1, wherein
the attachment information acquiring unit further acquires the attachment information linked to the electronic document related to the request accepted by the request accepting unit, and
the response outputting unit outputs the electronic document related to the request, the attachment information that is linked to the electronic document related to the request and is acquired by the attachment information acquiring unit, and the attachment information linked to the electronic document of which version is older than the electronic document related to the request.

3. The information processing apparatus according to claim 1, further comprising an attachment information accepting unit that accepts the attachment information uploaded by a user using a client terminal, wherein
the linking unit links the attachment information, of which upload is accepted by the attachment information accepting unit, to an electronic document stored in the storage device.

4. The information processing apparatus according to claim 3, wherein
the linking unit further links the attachment information, of which upload is accepted by the attachment information accepting unit, to one of portions in the electronic document that have been written by the user.

5. The information processing apparatus according to claim 1, further comprising:
an image generating unit that generates a captured image that includes a portion written by the user, from the electronic document.

6. The information processing apparatus according to claim 5, further comprising:
an uploading unit that uploads attachment information including the captured image.

7. The information processing apparatus according to claim 3, further comprising:
a detecting unit that detects a correction request comment related to a request to correct the electronic document, out of the attachment information linked to the electronic document; and
a message outputting unit that, when the correction request comment is detected, outputs a confirmation message to prompt the user to confirm the detected correction request comment.

8. The information processing apparatus according to claim 7, wherein
the message outputting unit outputs a confirmation message that includes the number of correction request comments detected by the detecting unit.

9. The information processing apparatus according to claim 7, further comprising a confirmation state managing unit that manages a state of a confirmation, by a predetermined user, of the correction request comment detected by the detecting unit, wherein
the message outputting unit outputs a confirmation message that includes the number of correction request comments which are detected by the detecting unit and of which confirmation state is unconfirmed.

10. The information processing apparatus according to claim 9, further comprising:
a determining unit that determines, when a new version of an electronic document is accepted, whether a correction request comment, of which confirmation state is unconfirmed, exists in attachment information linked to an old version of the electronic document; and
a warning outputting unit that outputs a warning when the determining unit determines that an unconfirmed correction request comment exists.

11. The information processing apparatus according to claim 1, wherein
the response outputting unit outputs the electronic document related to the request, the attachment information, and an upload content in the case where the electronic document of which version is older than the electronic document related to the request is accepted.

12. A method for a computer connected to a storage device for storing electronic documents, to execute:
a setting step of setting, for the electronic documents to be stored in the storage device, electronic document identification information by which an older version or a newer version can be determined among a plurality of sequential electronic documents;
a linking step of linking attachment information to an electronic document stored in the storage;
a request accepting step of accepting a request for an electronic document stored in the storage device;
an attachment information acquiring step of, in response to the request accepted in the request accepting step, acquiring the attachment information linked to an electronic document of which version is older than the electronic document related to the request, based on the electronic document identification information; and
a response outputting step of outputting, as a response to the request, the electronic document related to the request and the attachment information acquired in the attachment information acquiring step.

13. A non-transitory computer-readable medium recording a program allowing a computer connected to a storage device for storing electronic documents, to function as:
a setting unit that sets, for the electronic documents to be stored in the storage device, electronic document identification information by which an older version or a newer version can be determined among a plurality of sequential electronic documents;
a linking unit that links attachment information to an electronic document stored in the storage device;
a request accepting unit that accepts a request for an electronic document stored in the storage device;
an attachment information acquiring unit that, in response to the request accepting unit accepting a request, acquires the attachment information linked to an electronic document of which version is older than the electronic document related to the request, based on the electronic document identification information; and
a response outputting unit that outputs, as a response to the request, the electronic document related to the request and the attachment information acquired by the attachment information acquiring unit.
